(19) United States
(12) Patent Application Publication
(10) Pub. No.: US 2008/0310412 A1
(43) Pub. Date: Dec. 18, 2008

(54) INFORMATION RELAY APPARATUS, CONTROL METHOD AND INFORMATION PROCESSING SYSTEM

(75) Inventors: Hiroyuki WADA, Kawasaki (JP); Satoshi Nakagawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/197,729

(22) Filed: Aug. 25, 2008

Related U.S. Application Data
(63) Continuation of application No. PCT/JP2006/303642, filed on Feb. 27, 2006.

(51) Int. Cl. H04L 12/56

(52) U.S. Cl. 370/389

(57) ABSTRACT

In a multi-processor system, an exit control circuit unit 330 of a crossbar-network module 300 to which a plurality of nodes 200 are connected is provided with a staying-time monitoring circuit 410 for issuing a special BC packet 530 for all of the exit control circuits 330 when the staying-time of a PP packet 510 in a PP buffer 331 exceeds a predetermined value; a special BC packet detection circuit 420 for detecting the arrival of the special BC packet 530; and a mode switching unit 400 for performing switching, when the special BC packet 530 arrives, from a BC prioritized mode M1 for transmitting the BC packet 520 in a BC buffer 332 prior to the PP packet 510 in the PP buffer 331, to a PP prioritized mode M2 that gives priority to the PP packet 510 staying in the PP buffer 331 over the BC packet 520.

### CROSS REFERENCE TO RELATED APPLICATION

This application is a continuation of PCT application of PCT/JP2006/303642, which was filed on Feb. 27, 2006.

### BACKGROUND OF THE INVENTION

1. Field of the Invention

The present invention relates to an information relay apparatus, a control method of an information apparatus and an information processing system: for example, the present invention relates to a configuration and a control technique of a crossbar-network module for relaying a packet between a plurality of processors in a multi-processor system.

2. Description of the Related Art

As described in, for example, Patent Document 1, for a multi-processor system comprising a plurality of processors (nodes) connected through information transmission paths, use of crossbar network for the information transmission paths has been known, as it has advantages such as that a large bandwidth can be secured for communication between the processors. Between the processors, data transmission is performed in units of packet.

Meanwhile, communication between nodes in a multi-processor system involves a broadcast packet (hereinafter referred to as a BC packet) that is transmitted from one node to all nodes simultaneously, and a unicast packet (hereinafter referred to as a PP (point-to-point) packet) that is transmitted to a single node.

The BC packet is provided for purposes such as to share information for securing coherence between cache memories in a plurality of processors, and to make start/end of performance of a certain timing process synchronized between the plurality of processors.

Therefore, there exists a rule that a BC packet needs to be received in all nodes connected through a crossbar network simultaneously. The BC packet being received simultaneously in this context unit that the BC packet arrives at the destination nodes in the same cycle (at the same time), in a multi-processor system in which a plurality of nodes (processors) operate in accordance with a synchronized clock cycle.

Thus, since a BC packet needs to be transmitted to all nodes simultaneously, when a BC packet is determined to be transmitted at an exit to a node in a cycle, the transmission of the same BC packet has to be performed at exits to the other nodes. Transmission of a single different packet only to a certain node is not permitted.

Therefore, presence/absence of BC packet transmission restricts the timing at which a crossbar network can transmit a PP packet to an arbitrary node. The PP packet stays in an exit buffer and waits to be transmitted at the timing when no BC packet transmission is performed.

In this case, priority cannot be given to the BC packet transmission simply at all times, as it would cause inconvenience that the PP packet transmission is postponed and suspended for a long time when the BC packet transmission occurs continuously.

Then, certain periods could be specified by unit of time slots etc., in which a BC packet can be communicated through a bus in the crossbar network, to secure some periods in which no BC packet is transmitted and to allow a PP packet to be communicated in the periods that do not correspond to the time slots assigned for the BC packet.

The above measure, however, has a technical problem that regardless of presence/absence of the PP packet, the bandwidths in a crossbar network to be used for a BC packet are always restricted, resulting in decreases in throughput (amount of process performed per unit time) for the BC packet.

[Patent Document 1] Japanese Patent Application Publication No. 2001-167067

### SUMMARY OF THE INVENTION

An object of the present invention is to provide a technique, for an information processing system in which a broadcast packet (BC packet) to be transmitted to all nodes simultaneously and a unicast packet (PP packet) to be transmitted to a single node are transmitted through an information relay apparatus, to secure the maximum throughput for the BC packet, while assuring the transmission of the PP packet.

A first aspect of the present invention provides an information relaying apparatus for exchanging a packet transmitted and received between a plurality of nodes, each of the nodes connected to each of a plurality of node connection units disposed in the information relaying apparatus, comprising:

mode control unit for performing switching between

a first operation mode for transmitting, to the nodes, a second packet to be transmitted from one of the nodes to all of the nodes, prior to a first packet to be transmitted from one of the nodes to another of the nodes; and

a second operation mode for transmitting, to the nodes, the first packet prior to the second packet.

A second aspect of the present invention provides the information relaying apparatus according the first aspect, wherein

the mode control unit is disposed in each of the node connection units, the mode control unit comprising:

staying-time monitoring unit for issuing a third packet, in accordance with a staying time, in the node connection unit, of the first packet to be transmitted to the node, in order to notify the other node connection units of a switch from the first mode to the second mode; and

mode switching unit for performing switching from the first mode to the second mode for a predetermined period, when the third packet is received from another of the node connection units.

A third aspect of the present invention provides the information relaying apparatus according to the first aspect, wherein

each of the node connection units comprises an entrance control circuit for receiving the packet arriving from the nodes; and a plurality of exit control circuits for transmitting the packets to each of the nodes, the exit control circuit comprising the mode control unit.

A fourth aspect of the present invention provides the information relaying apparatus according to the first aspect, wherein the information relaying apparatus is a crossbar-network module comprising a crossbar network for connecting a plurality of the node connection units.

A fifth aspect of the present invention provides a control method of an information relaying apparatus for exchanging a packet transmitted and received between a plurality of nodes, each of the nodes connected to each of a plurality of node connection units disposed in the information relaying apparatus, the method comprising:

a first step for operating the information relaying apparatus according to a first operation mode for transmitting, to the nodes, a second packet to be transmitted from one of the nodes to all of the nodes, prior to a first packet to be transmitted from one of the nodes to another of the nodes; and

a second step for operating the information relaying apparatus according to a second operation mode for transmitting, to the nodes, a first packet temporarily prior to the second packet, in accordance with a staying time of the first packet to be transmitted to the node.

A sixth aspect of the present invention provides the control method of an information relaying apparatus according to the fifth aspect, wherein in the second step, a third packet for notifying the other node connection units of a switch from the first operation mode to the second operation mode is issued in accordance with the staying time of the first packet to be transmitted to the node; and

each of the node connection units switches from the first mode to the second mode for a predetermined period, when the third packet is received from another of the node connection units.

A seventh aspect of the present invention provides an information processing system comprising a plurality of nodes and an information relaying apparatus for exchanging a packet transmitted and received between the plurality of nodes, each of the nodes connected to each of a plurality of node connection units disposed in the information relaying apparatus,

the information relaying apparatus comprising:

mode control unit for performing switching between

a first operation mode for transmitting, to the nodes, a second packet to be transmitted from one of the nodes to all of the nodes, prior to a first packet to be transmitted from one of the nodes to another of the nodes; and

a second operation mode for transmitting, to the nodes, a first packet prior to the second packet.

An eighth aspect of the present invention provides the information processing system according to the seventh aspect, wherein

the mode control unit is disposed in each of the node connection units, the mode control unit comprising:

staying-time monitoring unit for issuing a third packet, in accordance with a staying time, in the node connection unit, of the first packet to be transmitted to the node, in order to notify the other node connection units of a switch from the first mode to the second mode; and

mode switching-unit for performing switching from the first mode to the second mode for a predetermined period, when the third packet is received from another of the node connection units.

Thus, the two states are defined in the present invention: the first operation mode (normal mode) that gives priority to the second packet (BC packet) and the second operation mode (PP prioritized mode) that gives priority to the first packet (PP packet), in an exit control circuit for a node in a crossbar network.

In the normal mode, priority is given to the BC packet transmission at all times, without restriction on the timing for the BC packet transmission. In the PP prioritized mode, the BC packet transmission is restricted by unit of time slots etc. The initial mode is the normal mode.

The staying-time monitoring-unit monitors how long a period has been continued for each node, during which “PP packets have been in an exit buffer and none has been transmitted”.

When the period continues for a certain amount of time, without a break, in an exit control circuit of a given node, the control circuit issues a third packet (special BC packet) that is different from both BC and PP packets, so as to notify exit control circuits for all nodes in the crossbar network that there exits a PP packet that has been waiting for a transmission for a long time, in one of the exit control circuits.

The exit control circuit of each node enters the PP prioritized mode for a certain period starting from the time it detects the special BC packet.

Meanwhile, the special BC packet is not to be transmitted to any node and is to be discarded by the exit control circuit that receives the packet, as the nodes do not need the special BC packet. In the PP prioritized mode, the BC packet transmission is restricted by unit of time slots, securing some periods in which the PP packet can be communicated.

When the certain period is over after the switch to the PP prioritized mode, the exit control circuits for all nodes return to the normal mode simultaneously.

The rule that prescribes the BC packet to be transmitted simultaneously can be followed according to the methods in the present invention, since the exit control circuits for all nodes detect the special BC packet simultaneously and the duration of the PP prioritized mode is the same for all nodes.

### BRIEF DESCRIPTION OF THE DRAWINGS

FIG. 1 is a schematic diagram of an example of configuration of an information processing system for realizing a control method of information processing system being an embodiment of the present invention.

FIG. 2 is a schematic diagram of an example of operation of an information processing system being an embodiment of the present invention.

FIG. 3 is a block diagram illustrating, in greater detail, configuration of a crossbar-network module constituting an information processing system being an embodiment of the present invention.

FIG. 4 is a schematic diagram showing configuration of a packet used in an information processing system being an embodiment of the present invention.

FIG. 5 is a schematic diagram showing configuration of a packet used in an information processing system being an embodiment of the present invention.

FIG. 6 is a schematic diagram showing configuration of a packet used in an information processing system being an embodiment of the present invention.

### DESCRIPTION OF THE PREFERRED EMBODIMENTS

Hereinafter, embodiments of the present invention are described, referring to the drawings.

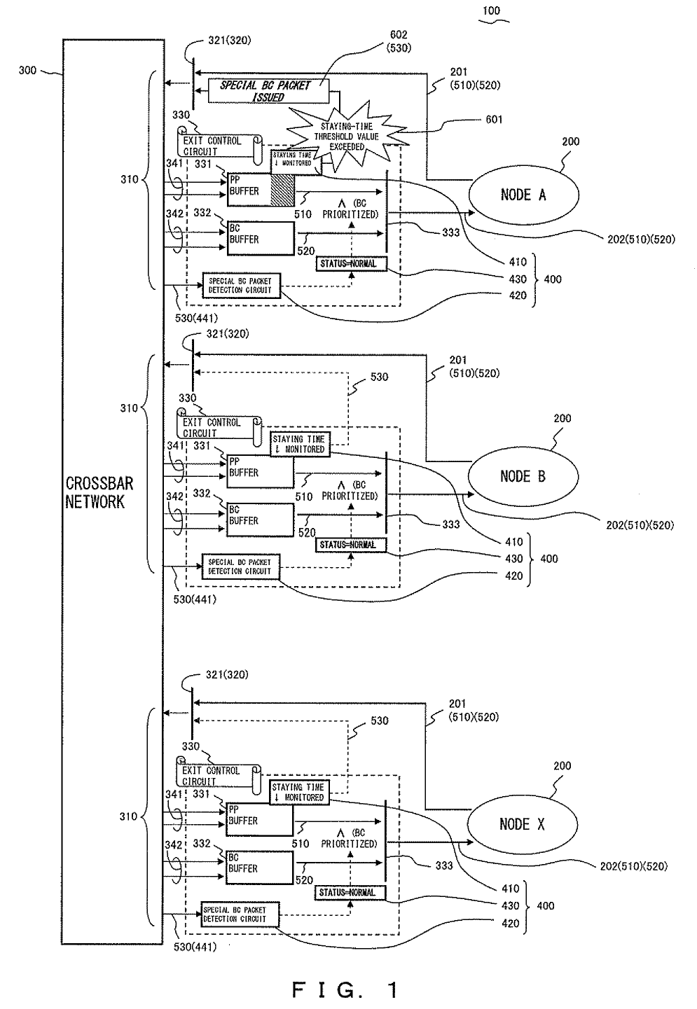

FIG. 1 is a schematic diagram of an example of configuration of an information processing system for realizing a control method of an information processing system being an embodiment of the present invention.

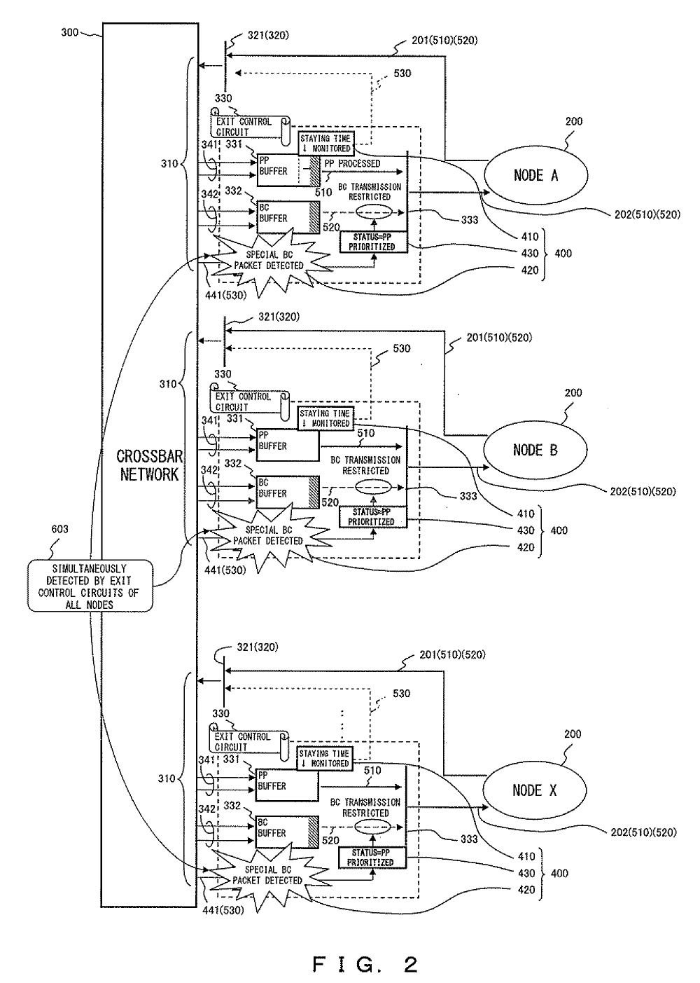

FIG. 2 is a schematic diagram of an example of operations of an information processing system being an embodiment of the present invention.

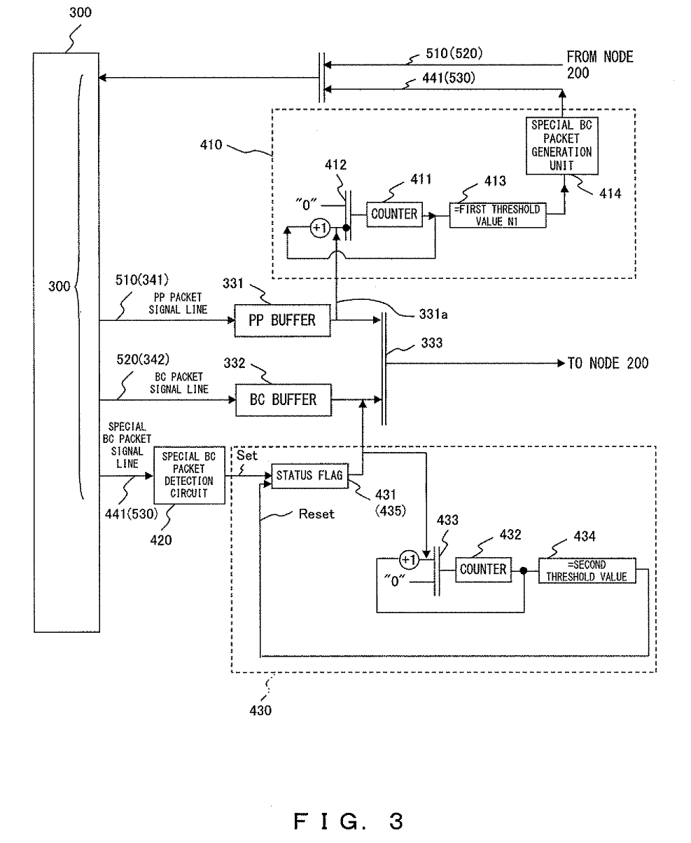

FIG. 3 is a block diagram illustrating, in greater detail, configuration of a crossbar-network module constituting an information processing system being an embodiment of the present invention.

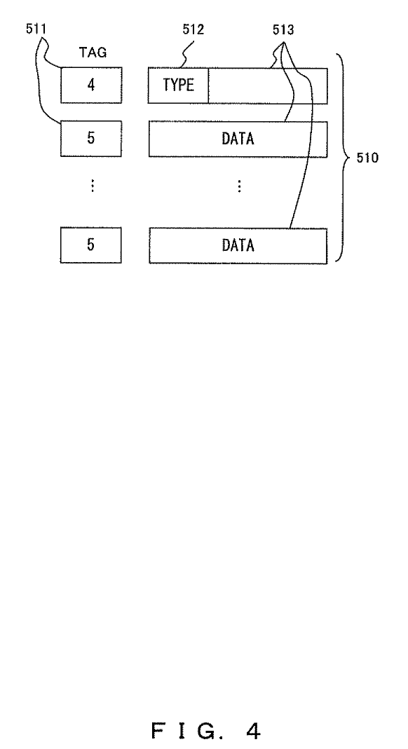

FIGS. 4, 5 and 6 are schematic diagrams showing configuration of packets used in an information processing system being an embodiment of the present invention.

As illustrated in FIG. 1, a multi-processor system 100 according to the embodiment comprises a plurality of nodes 200 and a crossbar-network module 300.

Each node 200 is, for example, a processor module comprising a central processing unit (CPU). Alternatively, the node 200 is a memory module shared by the processor module. Alternatively, the node 200 may be an input/output unit.

In addition, a plurality of crossbar-network modules 300 may be connected in multiple stages, so that they form a hierarchical structure, as needed.

In the following description, each node 200 is distinguished as node A, B . . . X, when needed.

Each of the nodes 200 is connected to the crossbar-network module 300 via a transmission bus 201 and a reception bus 202.

Via the crossbar-network module 300, transmission and reception of information such as a PP packet 510 (first packet) and a BC packet 520 (second packet) between the plurality of nodes 200 are performed.

The PP packet 510 is a unicast packet (point-to-point packet) that is transmitted from one of the nodes 200 to another of the nodes 200.

The BC packet 520 is a broadcast (BC) packet that is transmitted from one of the nodes 200 to all of the nodes 200 simultaneously.

The crossbar-network module 300 comprises a plurality of node connection units 310 to which the transmission bus 201 and the reception bus 202 of each node are connected.

Each of the node connection units 310 comprises an entrance control circuit unit 320 to which the transmission bus 201 is connected, and an exit control circuit unit 330 to which the reception bus 202 is connected.

The entrance control circuit unit 320 comprises a selector 321. The selector 321 performs operations to select and input, to the crossbar-network module 300, either of a PP packet 510 or a BC packet 520 arriving from the nodes 200 via the transmission bus 201, or a special BC packet 530 (third packet) arriving from a staying-time monitoring circuit 410 (to be described later).

The exit control circuit unit 330 comprises a PP buffer 331, a BC buffer 332 and a selector 333.

The PP buffer 331 is connected to the crossbar-network module 300 via a PP packet signal line 341 and stores the PP packet 510 arriving via the crossbar-network module 300.

The BC buffer 332 is connected to the crossbar-network module 300 via a BC packet signal line 342, and stores the BC packet 520 arriving from the crossbar-network module 300.

The selector 333 performs operations to select either of the PP buffer 331 or the BC buffer 332, and to connect to the reception bus 202, so as to transmit the PP packet 510 in the PP buffer 331 or the BC packet 520 in the BC buffer 332 to the corresponding node 200.

According to the embodiment, in the normal operation status (a BC prioritized mode M1 (first operation mode)), when the BC packet 520 exists in the BC buffer 332, priority is given to the BC buffer 332 and the BC buffer 332 is connected to the selector 333 regardless of presence/absence of the PP packet 510 in the PP buffer 331, to transmit the BC packet 520 to the node 200 (reception bus 202).

When no BC packet 520 exists in the BC buffer 332 and the PP packet 510 exits in the PP buffer 331, the PP packet 510 is transmitted to the reception bus 202 of the node 200.

In the BC prioritized mode M1, when the transmission of the BC packet 520 is caused continuously in the BC buffer 332 by a certain factor, a transmission delay occurs, suspending, for a long time, the transmission of the PP packet 510 stored in the PP buffer 331.

To cope with the above issue, the present embodiment realizes a PP prioritized mode M2 (second operation mode) in which higher priority is given temporarily to the transmission of PP packet 510 staying in the PP buffer 331, over the transmission of the BC packet 520 in the BC buffer 332, by providing a mode switching unit 400 (mode control unit) in each exit control circuit unit 330.

According to the embodiment, the instruction to switch from the BC prioritized mode M1 and the PP prioritized mode M2 is performed by synchronized transmission of a special BC packet 530 from one of the exit control circuit units 330 to the other exit control circuit units 330.

Referring to FIG. 3, an example is described for configuration of a mode switching unit 400 installed in the exit control circuit unit 330 at each of the node connection units 310 of the crossbar-network module 300.

The mode switching unit 400 according to the embodiment comprises a staying-time monitoring circuit 410, a special BC packet detection circuit 420 (mode switching unit) and a priority switching unit 430 (mode switching unit).

The staying-time monitoring circuit 410 comprises a staying-time counter 411, a counter input selector 412, a staying-time judgment unit 413 and a special BC packet generation unit 414

The staying-time counter 411 monitors the staying time of the first one of the PP packets 510 waiting for the transmission in the PP buffer 331.

Specifically, the PP buffer 331 transmits a staying signal 331a to the staying-time monitoring circuit 410, the staying signal 331a being TRUE (“1”) when the PP packet 510 is staying in the PP buffer 331, and FALSE (“0”) once a transmission of the PP packet 510 is performed.

The counter input selector 412 in the staying-time monitoring circuit 410 inputs and adds, to the staying-time counter 411, “1” when the staying signal 331a is TRUE, and when the staying signal 331a is FALSE, inputs “0” to the staying-time counter 411 to reset the counter.

Thus, the staying-time counter 411 is provided with a counter value that is proportional to the staying time of the PP packet 510 staying in the PP buffer 331.

When the counter value exceeds a predetermined first threshold value N1, the staying-time judgment unit 413 instructs the special BC packet generation unit 414 to generate a special BC packet 530 and reset the counter value to 0.

The first threshold value N1 is externally and arbitrarily configurable.

The special BC packet generation unit 414 generates and transmits, to the selector 321 in the entrance control circuit unit 320, a special BC packet 530 in accordance with the instruction from the staying-time judgment unit 413.

Meanwhile, the special BC packet detection circuit 420 is connected to the crossbar-network module 300 (node connection unit 310) via a special packet signal line 441. The special BC packet detection circuit 420 detects arrival of the special BC packet 530 from the staying-time monitoring circuit 410 provided in another entrance control circuit unit 320, and instructs the priority switching unit 430 to perform switching from the normal BC prioritized mode M1 to the PP prioritized mode M2.

As described above, the BC prioritized mode M1 is an operation status that gives priority to the transmission of the BC packet 520 from the BC buffer 332 to the reception bus 202 of the node 200.

The PP prioritized mode M2 is an operation status that gives priority temporarily to the transmission of the PP packet 510 in a PP buffer 331 over the transmission of the BC packet 520 in a BC buffer 332, to the reception bus 202 of the node 200.

The priority switching unit 430 comprises a mode setting register 431, a duration counter 432, a counter input selector 433, and a bandwidth restriction-period judgment unit 434.

The mode setting register 431 has a status flag 435. The status flag 435 is set to TRUE (“1”) (the PP prioritized mode M2 becomes valid) by the special BC packet detection circuit 420, and to FALSE (“0”) (the BC prioritized mode M1 becomes valid) by the bandwidth restriction-period judgment unit 434.

Specifically, the special BC packet detection circuit 420 sets the TRUE status flag 435 in the mode setting register 431 to switch the operation status from the BC prioritized mode M1 to the PP prioritized mode M2.

Meanwhile, the counter input selector 433 inputs “1” to the duration counter 432 when the status flag 435 becomes TRUE, and inputs “0” to reset the counter when the status flag 435 is FALSE. Thus, the counter value of the duration counter 432 increases only during the period in which the status flag 435 is TRUE (while the PP prioritized mode M2 is valid).

The bandwidth restriction-period judgment unit 434 sets the status flag 435 in the mode setting register 431 to FALSE when the counter value of the duration counter 432 exceeds a predetermined second threshold value N2, to reset the operation mode from the PP prioritized mode M2 to the normal BC prioritized mode M1.

The second threshold value N2 is externally and arbitrarily configurable.

Thus, the control to temporarily switch the operation mode from the BC prioritized mode M1 to the PP prioritized mode M2 only during the period starting from the arrival of the special BC packet 530 to the special BC packet detection circuit 420 and defined by the second threshold value N2 is realized.

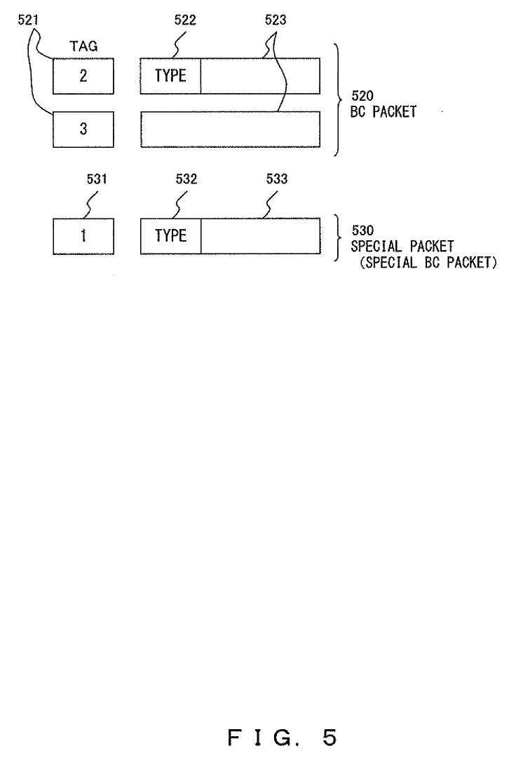

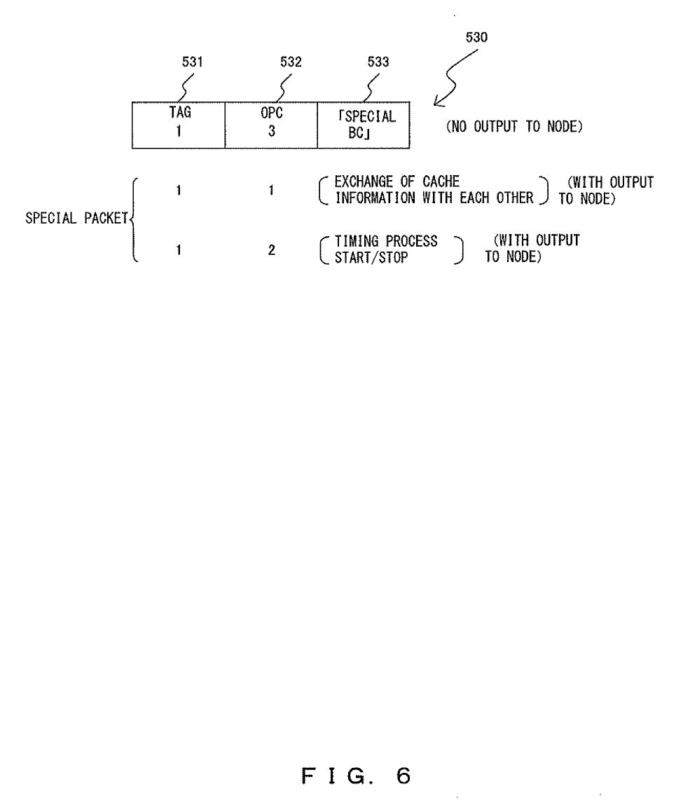

Here, the PP packet 510, the BC packet 520 and the special BC packet 530 in the embodiment are explained, referring to FIG. 4, FIG. 5 and FIG. 6.

As illustrated in FIG. 4, the PP packet 510 comprises a tag part 511, a type information part 512 and a data part 513.

The value “4” or “5” is set in the tag part 511. In other words, the PP packet 510 consists of one or more sequential packet (s), in which “4” is set in the tag part 511 of the first packet, whereas “5” is set in all tag parts 511 of the subsequent packets.

In the type information part 512, information is set, including information for the reception side to identify the packet as a PP packet 510, an instruction code, identification information (a node ID, address) of the destination node 200.

Data for transmission is set in the data part 513.

As illustrated in FIG. 5, the BC packet 520 comprises a tag part 521, a type information part 522 and a data part 523.

The value “2” or “3” is set in the tag part 521. In other words, the BC packet 520 consists of one packet or two sequential packets, in which “2” is set in the tag part 521 of the first packet, whereas “3” is set in the tag part 521 of the subsequent packet.

In the type information part 522, information is set, including information for the reception side to identify the packet as a BC packet 520 for synchronized transmission to a plurality of nodes 200, and an instruction code.

Data for synchronized transmission is set in the data part 523.

The present embodiment also involves the special BC packet 530 in addition to the packets described above. The special BC packet 530 is implemented as a type of special packets.

The special BC packet 530 is generated and discarded within the crossbar-network module 300 and the exit control circuit unit 330, without being transmitted to the nodes 200, which totally differs from common special packets and from the PP packet 510 and the BC packet 520 described above.

The special BC packet 530 comprises a tag part 531, a type information part 532 and a data part 533.

The value “1” is set in the tag part 531 to indicate the packet as a type of special packets.

In the type information part 532, information is set, including information for the reception side to identify the packet as a special BC packet 530, and an instruction code.

Data for transmission is set in the data part 533.

FIG. 6 shows the difference between a common special packet and the special BC packet 530 according to the embodiment.

The special BC packet 530 is distinguished from common special packets in that “3” is set in the type information part 532 in the special BC packet 530.

Meanwhile, in common special packets, for example, when the value “1” set in the type information part 532 as the instruction code, it indicates that information in cache memories are to be exchanged between the nodes 200, and information for exchange is set in the data part 533.

In the same manner, when the value “2” set in the type information part 532 as the instruction code, it indicates that synchronization of start/end of a timing operation between the nodes 200 is to be performed, and required information is set in the data part 533.

Hereinafter an example of operation according to the present embodiment is described.

First, in the initial status, the FALSE flag 435 is set in the mode setting register 431 of the mode switching unit 400 in each exit control circuit unit 330, being in the normal status (BC prioritized mode M1) that gives priority to the transmission of the BC packet 520 in the BC buffer 332 over the transmission of the PP packet 510 in the PP buffer 331.

In this status, the PP packet 510 generated in a given node 200 is input to the crossbar-network module 300 via the transmission bus 201 and the entrance control circuit unit 320 (selector 321), then arrives and stored in the PP buffer 331 in the exit control circuit unit 330 corresponding to the destination node 200.

When no BC packet 520 exits in the BC buffer 332 in the corresponding exit control circuit unit 330, the selector 333 selects and transmits, to the destination node 200 (reception bus 202), the PP packet 510 in the PP buffer 331.

Meanwhile, the BC packet 520 generated in a given node 200 is input to the crossbar-network module 300 via the transmission bus 201 and entrance control circuit unit 320 (selector 321), and then arrives at the BC buffer 332 in all of the exit control circuit units 330.

The selector 333 in all of the exit control circuit unit 330 then selects and transmits simultaneously, to each node 200 (reception bus 202) corresponding to the exit control circuit units 330, the BC packet 520 in the BC buffer 332 regardless of presence/absence of the PP packet 510 in the PP buffer 331.

Thus, the BC prioritized mode M1 assures the synchronized transmission of the BC packet 520 to all of the nodes 200.

According to the present embodiment, when the PP packet 510 arrives in the PP buffer 331 in each exit control circuit unit 330, the staying-time monitoring circuit 410 detects the presence of PP packet 510 in the PP buffer 331 from the staying signal 331a and the counter input selector 412 switches its input to the staying-time counter 411 from “0” to “1”, starting the addition for the staying-time counter 411.

When the transmission of the PP packet 510 is performed, the staying signal 331a becomes FALSE and “0” is input to the staying-time counter 411 via the counter input selector 412, resetting the counter value to “0”.

When priority is given to the transmission of the BC packet 520 over the PP packet 510 staying in the PP buffer 331, the staying-time monitoring circuit 410 continues the addition for the staying-time counter 411.

When, for example, the counter value of the staying-time counter 411 in the exit control circuit unit 330 at the node connecting unit 310 corresponding to the node A (node 200) in FIG. 1 exceeds the predetermined first threshold N1, in other words, when the staying-time of the PP packet 510 in the PP buffer 331 exceeds a predetermined amount of time (event 601), the staying-time judgment unit 413 instructs the special BC packet generation unit 414 to generate the special BC packet 530.

The special BC packet generation unit 414 generates the special BC packet 530 in response to the generation instruction and issues the special BC packet 530 to the crossbar-network module 300 via the selector 321 in the entrance control circuit unit 320 (event 602).

The special BC packet 530 issued as described as described above is distributed to all of the exit control circuit units 330 and detected by each special BC packet detection circuit 420 simultaneously (event 603).

In each of the exit control circuit units 330 that detected the arrival of the special BC packet 530 simultaneously, the status flag 435 in the mode setting register 431 of the priority switching unit 430 is set to TRUE, and at the same time, the operation mode is switched from the BC prioritized mode M1 to the PP prioritized mode M2 simultaneously.

With the switch to the PP prioritized mode M2, the selector 333 gives priority to the transmission of the PP packet 510 in the PP buffer 331 to the node 200 (transmission bus 201).

For example, in the PP prioritized mode M2, the selector 333 restricts the bandwidth of the transmission of the BC packet 520 so that one BC packet 520 is transmitted per n cycles, to give to the transmission of the PP packet 510.

Meanwhile, triggered by the switch from the BC prioritized mode M1 to the PP prioritized mode M2, the counter input selector 433 of the priority switching unit 430 changes its input to the duration counter 432 from “0” to “1”, starting the addition for the counter value at the duration counter 432.

When the counter value of the duration counter 432 exceeds the predetermined second threshold value N2, in other words, when the PP prioritized mode M2 has been continued for a predetermined amount of time, the flag 435 in the mode setting register 432 is set to FALSE, resetting the operation status from the PP prioritized mode M2 to the normal BC prioritized mode M1.

As described above, according to the embodiment, the staying-time monitoring circuit 410 monitors in each exit control circuit unit 330 monitors the staying-time of the PP packet 510 in the PP buffer 331, and when the staying-time exceeds the amount of time defined by the first threshold value N1, the special BC packet 530 is transmitted to all of the exit control circuit units 330, switching the operation status temporarily (only for the period of time defined by the second threshold value N2) from the BC prioritized mode M1 to the PP prioritized mode M2.

Thus, the transmission delay where the PP packet 510 stays in the PP buffer 331 for a long time can be prevented, even when the transmission of the BC packet 520 via the BC buffer 332 occurs continuously.

Specifically, the synchronized transmission of the BC packet 520 giving priority over the BC packet 520 over the PP packet 510 can be realized without constant restriction on the transmission bandwidth of the BC packet 520 via the crossbar-network module 300 (without decreasing the throughput for the BC packet 520), while realizing, at the same time, the prevention of the transmission delay caused for the PP packet 510 with the low priority.

In other words, the PP packet 510 and the BC packet 520 can be transmitted at high speeds through efficient use of the transmission bandwidth provided by the crossbar-network module 300.

In addition, the staying-time of the PP packet 510 in the PP buffer 331 and the duration of the PP prioritized mode M2 can be arbitrarily modified, by selecting the predetermined values of the first threshold value N1 and the second threshold value N2 as needed, making it possible to set the appropriate operating conditions of the BC prioritized mode M1 and the PP prioritized mode M2, in accordance with the operation status of the multi-processor system 100.

The present invention is not limited to the configurations illustrated in the above embodiments, and various changes can be made, without departing from the purpose of the present invention.

According to the present invention, in an information processing system that performs transmission, via an information relaying apparatus, of a broadcast packet (BC) packet to be transmitted to all nodes simultaneously and a unicast packet (PP packet) to be transmitted to a single node, the maximum throughput for the BC packet can be secured, while assuring the transmission of the PP packet.

What is claimed is:

1. An information relaying apparatus for exchanging a packet transmitted and received between a plurality of nodes, each of the nodes connected to each of a plurality of node connection units disposed in the information relaying apparatus, comprising:
mode control unit for performing switching between
a first operation mode for transmitting, to the nodes, a second packet to be transmitted simultaneously from one of the nodes to all of the nodes, prior to a first packet to be transmitted from one of the nodes to another of the nodes; and
a second operation mode for transmitting, to the nodes, the first packet prior to the second packet.

2. The information relaying apparatus according to claim 1, wherein
the mode control unit is disposed in each of the node connection units, the mode control unit comprising:
staying-time monitoring unit for issuing a third packet, in accordance with a staying time, in the node connection unit, of the first packet to be transmitted to the node, in order to notify all node connection units of a switch from the first mode to the second mode; and
mode switching unit for performing switching from the first mode to the second mode for a predetermined period, when the third packet is received from one of the node connection units.

3. The information relaying apparatus according to claim 1, wherein
each of the node connection units comprises an entrance control circuit for receiving the packet arriving from the nodes; and a plurality of exit control circuits for transmitting the packets to each of the nodes, the exit control circuit comprising the mode control unit.

4. The information relaying apparatus according to claim 1, wherein the information relaying apparatus is a crossbar-network module comprising a crossbar network for connecting a plurality of the node connection units.

5. A control method of an information relaying apparatus for exchanging a packet transmitted and received between a plurality of nodes, each of the nodes connected to each of a plurality of node connection units disposed in the information relaying apparatus, the method comprising:
a first step for operating the information relaying apparatus according to a first operation mode for transmitting, to the nodes, a second packet to be transmitted simultaneously from one of the nodes to all of the nodes, prior to a first packet to be transmitted from one of the nodes to another of the nodes; and
a second step for operating the information relaying apparatus according to a second operation mode for transmitting, to the nodes, a first packet temporarily prior to the second packet, in accordance with a staying time of the first packet to be transmitted to the node.

6. The control method of an information relaying apparatus according to claim 5, wherein
in the second step, a third packet for notifying all node connection units of a switch from the first operation mode to the second operation mode is issued in accordance with the staying time of the first packet to be transmitted to the node; and
each of the node connection units switches from the first mode to the second mode for a predetermined period, when the third packet is received from one of the node connection units.

7. An information processing system comprising a plurality of nodes and an information relaying apparatus for exchanging a packet transmitted and received between the plurality of nodes, each of the nodes connected to each of a plurality of node connection units disposed in the information relaying apparatus,
the information relaying apparatus comprising:
mode control unit for performing switching between
a first operation mode for transmitting, to the nodes, a second packet to be transmitted simultaneously from one of the nodes to all of the nodes, prior to a first packet to be transmitted from one of the nodes to another of the nodes; and
a second operation mode for transmitting, to the nodes, a first packet prior to the second packet.

8. The information processing system according to claim 7, wherein
the mode control unit is disposed in each of the node connection units, the mode control unit comprising:
staying-time monitoring unit for issuing a third packet, in accordance with a staying time, in the node connection unit, of the first packet to be transmitted to the node, in order to notify all node connection units of a switch from the first mode to the second mode; and
mode switching unit for performing switching from the first mode to the second mode for a predetermined period, when the third packet is received from one of the node connection units.
